(19) United States
(12) Patent Application Publication
(10) Pub. No.: US 2016/0210266 A1
(43) Pub. Date: Jul. 21, 2016

(54) METHOD FOR PREDICTING HYSTERESIS CURVE MODEL OF MAGNETORHEOLOGICAL SYSTEM

(71) Applicant: National Tsing Hua University, Hsinchu (TW)

(72) Inventor: Jia-Ying Tu, Hsinchu (TW)

(21) Appl. No.: 14/684,811

(22) Filed: Apr. 13, 2015

(30) Foreign Application Priority Data
Jan. 15, 2015 (TW) 104101309

(51) Int. Cl. G06F 17/16; G06F 17/50; F16D 57/00; F16F 9/53; F16D 37/02

(52) U.S. Cl. CPC G06F 17/16; F16F 9/535; F16D 37/02; F16D 57/002; G06F 17/5009; F16D 2121/20

(57) ABSTRACT

The present invention claims a method for predicting a hysteresis curve model of a magnetorheological system based on Equation 1: \ddot{x}+αx+γ\dot{x}+βxⁿ+δ\dot{x}ⁿ=k₁d+c₁\dot{d} and Equation 2: y=A_{f}\dot{x}, wherein α, β, γ and δ are parameters of the magnetorheological system, n being an odd number, k₁ and c₁ being input parameters of the magnetorheological system, d and \dot{d} respectively being an physical input and a first-order differential of the input value, A_{f} being an output coefficient of the magnetorheological system, x being an internal state of the magnetorheological system, and y being an output of the magnetorheological system. The method has advantages of continuity and simple computation and features the ability to track parameter modifications. Therefore, the present invention promotes the computation efficiency and accuracy of the hysteresis model and makes the succeeding compensation design easier and the performance thereof more stable.

### FIELD OF THE INVENTION

The present invention relates to a method for predicting a hysteresis curve model of a magnetorheological system, particularly to a method using a nonlinear continuous second order ordinary differential equation to predict the hysteresis curve model of a magnetorheological system.

### BACKGROUND OF THE INVENTION

Magnetorheological phenomena occur in a magnetorheological fluid (MRF), which is a smart fluid primarily including magnetic particles and carrier oil. While a magnetic field acts on a magnetorheological fluid, the viscosity and yield stress thereof increases with the increasing intensity of the magnetic field. Once the magnetic field disappears, the magnetorheological fluid would be restored to be the original Newtonian fluid. The mechanism of the abovementioned phenomena is: while a magnetic field acts on a magnetorheological fluid, the magnetic particles of the magnetorheological fluid will be arranged to have a chain-like structure. Thus, the original Newtonian fluid is immediately converted into a Bingham plastic fluid with the viscosity and yield stress thereof increasing. As the variation of the viscosity and yield stress of a magnetorheological fluid is continuous, reversible and controllable, it is applied to mechanical and civil engineering industries, such as vibration-reducing dampers, brake devices, shock absorbers, and clutches.

The conventional technology adopts simulation methods to analyze the hysteresis and magnetorheological properties of a magnetorheological fluid. Among them, the Bingham model and the Bouc-Wen model are frequently used technologies. For example, a China Patent No. CN102175572 disclosed a microscopic-sense method for dynamically predicting the variation of the yield stress of a magnetorheological fluid, which comprises

Step 1: setting the material parameters of a magnetorheological fluid for a molecular dynamics simulation;
Step 2: establishing a Langevin equation of the movement of suspending particles under a multi-field coupling effect, and constructing a large-scale molecular dynamics simulation program, wherein the equation is expressed as

$$\overline{m} \frac{{\partial }^{2} {r}_{i}}{\partial {t}^{2}} = {F}_{h} ( {v}_{i} ) + {\sum }_{j \neq 1} {F}_{d} ( {r}_{ij} ) + {\sum }_{j \neq 1} {F}_{r} ( {r}_{ij} ) + {F}_{W} + {F}_{B} + {F}_{g}$$

wherein m̅ is the mass of a particle i, rᵢ the position vector of the particle i, Fₕ(vᵢ) the Stokes force of the flow field, F_{d}(rᵢⱼ) the magnetic force of a dipole in the magnetic field, Fᵣ(rᵢⱼ) the short range force of the particle field, F_{W} the force of the boundary field, F_{b} the Brownian force vector of the random field, and F_{g} the force vector of the gravity field;
Step 3: using the molecular dynamics simulation program to simulate the microscopic structure of the magnetorheological fluid; Step 4: constructing a macroscopic yield stress model intrinsically containing information of microscopic random particle movements, and statistically obtaining a basic relationship of stress and strain, which involves nonlinear and random variation, according to the result of simulating the microstructure evolution of the magnetorheological fluid, wherein the relationship is expressed as

ε^{c}(H,γ,\dot{γ},Θ)=ε^{f}(H,γ,\dot{γ},ω̅)

wherein ε^{c} and ε^{f} are respectively the microscopic system energy and the macroscopic system energy, and wherein H, γ and \dot{γ} are respectively the intensity of the applied magnetic field, the shear strain and the shear strain rate, and wherein ω̅ represents the basic stochastic events, including the stochasticity of the primitive structure of the suspended particles, the stochasticity of the initial velocity, and the influence of Brownian motions, and wherein Θ=Θ(ω̅) represents the nonlinear mapping of the stochasticity of the microscopic structure during the conversion process from the microscopic scale to the macroscopic scale, whereby is obtained a volume-based macroscopic yield stress expressed as

$${τ}^{c} ( H , γ , \dot{γ} , Θ ) = - \frac{{ɛ}^{f} ( H , γ , \dot{γ} , \overline{ω} )}{υ}$$

wherein υ is the volume of the magnetorheological fluid; Step 5: constructing a basic Bingham shear rate model containing random parameters and expressed as

τ(H,\dot{γ},Θ)=[τ₀(H,Θ)+K|\dot{γ}|]sgn(\dot{γ})

wherein \dot{γ} is the shear rate, τ₀ the constrained yield stress related to the applied magnetic field H and dependent on the random parameter vector Θ, K a fluid parameter greater than zero and dependent on the random parameter vector Θ; supposing that the macroscopic system is isotropic. Following, a shear rate obtained from the basic Bingham shear rate mode is expressed as

$$τ ( H , \dot{γ} , Θ ) = {max}_{γ} [ {τ}^{c} ( H , γ , \dot{γ} , Θ ) ]$$

Further, the prior art uses the least square fitting criterion to identify the parameters τ₀ and K of the Bingham model and define the variance thereof, wherein the material parameters of the magnetorheological fluid include the temperature field, the magnetic field and the shear field.

From the above description, it is learned: the Bingham model-based method needs complicated computation and involves discontinuity, piecewiseness and singularity. Therefore, the Bingham model-based method suffers from a complicated and difficult analysis process and lacks utility.

### SUMMARY OF THE INVENTION

The primary objective of the present invention is to solve the problem: the conventional model for predicting the hysteresis curve of a magnetorheological fluid needs complicated computation.

To achieve the abovementioned objective, the present invention proposes a method for predicting a hysteresis curve model of a magnetorheological system, which comprises

Step 1: providing a magnetorheological system at a fixed magnetic field and providing Equation 1 and Equation 2 respectively expressed as

\ddot{x}+αx+γ\dot{x}+βxⁿ+δ\dot{x}ⁿ=k₁d+c₁\dot{d} (1)

y=A_{f}\dot{x} (2)

wherein α, β, γ and δ are parameters of the magnetorheological system, n an odd number, k₁ and c₁ input parameters of the magnetorheological system, d and \dot{d} respectively an physical input and a first-order differential of the input value, A_{f} an output coefficient of the magnetorheological system, x an internal state of the magnetorheological system, and y an output of the magnetorheological system;
Step 2: fixing the magnetic field applied to the magnetorheological system, and measuring the magnetorheological system to obtain an experimental y-d curve and an experimental y-\dot{d} curve;
Step 3: selecting a plurality of groups of values of k₁, c₁, α, β, γ, δ, n and A_{f} according to the experimental y-d curve and the experimental y-\dot{d} curve;
Step 4: substituting the values into Equation 1 and Equation 2 to obtain a plurality of computed y-d curves and a plurality of computed y-\dot{d} curves;
Step 5: respectively fitting the computed y-d curves and the computed y-\dot{d} curves to the experimental y-d curve and the experimental y-\dot{d} curve to obtain the values of k₁, c₁, α, β, γ, δ, n and A_{f} corresponding to the coincidence of the computed y-d curve and the experimental y-d curve and the coincidence of the computed y-\dot{d} curve and the experimental y-\dot{d} curve; and
Step 6: substituting the values of k₁, c₁, α, β, γ, δ, n and A_{f}, which are obtained in Step 5, into Equation 1 and Equation 2 to obtain a model for dynamically predicting the hysteresis curve of the magnetorheological system.

In the present invention, the method for predicting a hysteresis curve model of a magnetorheological system is derived from the Duffing Equation, adopting a nonlinear continuous second-order ordinary differential equation. In comparison with the conventional method, the method of the present invention has advantages of continuity and simple computation and features the ability to track parameter modifications. Therefore, the present invention can promote the computation efficiency and accuracy of the hysteresis model.

### BRIEF DESCRIPTION OF THE DRAWINGS

FIG. 1 shows a y-\dot{d} curve according to one embodiment of the present invention.

### DETAILED DESCRIPTION OF THE PREFERRED EMBODIMENTS

The present invention discloses a method for predicting a hysteresis curve model of a magnetorheological system, which comprises Steps 1-6.

In Step 1, provide a magnetorheological system whose hysteresis curve is to be predicted and provide Equation 1 and Equation 2 respectively expressed as

\ddot{x}+αx+γ\dot{x}+βxⁿ+δ\dot{x}ⁿ=k₁d+c₁\dot{d} (1)

y=A_{f}\dot{x} (2)

wherein α, β, γ and δ are parameters of the magnetorheological system, n an odd number, k₁ and c₁ input parameters of the magnetorheological system, d and \dot{d} respectively an physical input value and a first-order differential of the input value, A_{f} an output coefficient of the magnetorheological system, x an internal state of the magnetorheological system, and y an output of the magnetorheological system.

In Step 2, fix the magnetic field, and measure the magnetorheological system to obtain an experimental y-d curve and an experimental y-\dot{d} curve.

In Step 3, select a plurality of groups of values of k₁, c₁, α, β, γ, δ, n and A_{f} according to the experimental y-d curve and the experimental y-\dot{d} curve.

In Step 4, substitute the values into Equation 1 and Equation 2 to obtain a plurality of computed y-d curves and a plurality of computed y-\dot{d} curves.

In Step 5, respectively fit the computed y-d curves and the computed y-\dot{d} curves to the experimental y-d curve and the experimental y-\dot{d} curve to obtain the values of k₁, c₁, α, β, γ, δ, n and A_{f} corresponding to the coincidence of the computed y-d curve and the experimental y-d curve and the coincidence of the computed y-\dot{d} curve and the experimental y-\dot{d} curve.

In Step 6, substitute the values of k₁, c₁, α, β, γ, δ, n and A_{f}, which are obtained in Step 5, into Equation 1 and Equation 2 to obtain a model for dynamically predicting the hysteresis curve of the magnetorheological system.

In details, α represents an effective linear stiffness coefficient of the magnetorheological system; β represents an effective nonlinear stiffness coefficient of the magnetorheological system; γ represents an effective linear damping coefficient of the magnetorheological system; δ represents an effective nonlinear damping coefficient of the magnetorheological system; n is an odd number and represents the degree of the nonlinearity; k₁ and c₁ are input parameters of the magnetorheological system and represent the intensities of the inputs to the magnetorheological system.

In Step 1, Equation 1 and Equation 2 may be further represented by state-space functions, which are respectively expressed as Equation 3 and Equation 4:

$$\begin{matrix}[ \begin{matrix}{\dot{x}}_{1} \\ {\dot{x}}_{2}\end{matrix} ] = [ \begin{matrix}0 & 1 \\ - α & - γ\end{matrix} ] [ \begin{matrix}{x}_{1} \\ {x}_{2}\end{matrix} ] + [ \begin{matrix}0 & 0 \\ - β {x}_{1}^{n} & - δ {x}_{2}^{n}\end{matrix} ] + [ \begin{matrix}0 & 0 \\ {k}_{1} & {c}_{1}\end{matrix} ] [ \begin{matrix}d \\ \dot{d}\end{matrix} ] & ( 3 ) \\ y = [ \begin{matrix}0 & {A}_{f}\end{matrix} ] [ \begin{matrix}{x}_{1} \\ {x}_{2}\end{matrix} ] & ( 4 )\end{matrix}$$

wherein

$$[ \begin{matrix}{\dot{x}}_{1} \\ {\dot{x}}_{2}\end{matrix} ] \qquad$$

represents a state vector containing x₁ and x₂ and x₁=x and x₂=\dot{x};

$$[ \begin{matrix}0 & 1 \\ - α & - γ\end{matrix} ] \qquad$$

represents a linear plant matrix of the magnetorheological system; [0 A_{f}] represents an hysteresis output matrix of the magnetorheological system; y represents an hysteresis output signal;

$$[ \begin{matrix}0 & 0 \\ {k}_{1} & {c}_{1}\end{matrix} ] \qquad$$

represents an input matrix of an hysteresis input signal of the magnetorheological system;

$$[ \begin{matrix}0 & 0 \\ - β {x}_{1}^{n} & - δ {x}_{2}^{n}\end{matrix} ] \qquad$$

represents a nonlinear dynamics matrix of the magnetorheological system.

In Step 2, the value of A_{f} is determined according to the measured maximum value of y; values of n and c₁ are determined according to the nonlinearity of the experimental y-\dot{d} curve; next the values of k₁, δ and c₁ are modified according to an area and a length of a hysteresis loop of the experimental y-\dot{d} curve; next the value of γ is modified according to a width and a linearity of the hysteresis loop of the experimental y-\dot{d} curve; then the values of a and β are modified according to a width and a length of a hysteresis loop of the experimental y-\dot{d} curve.

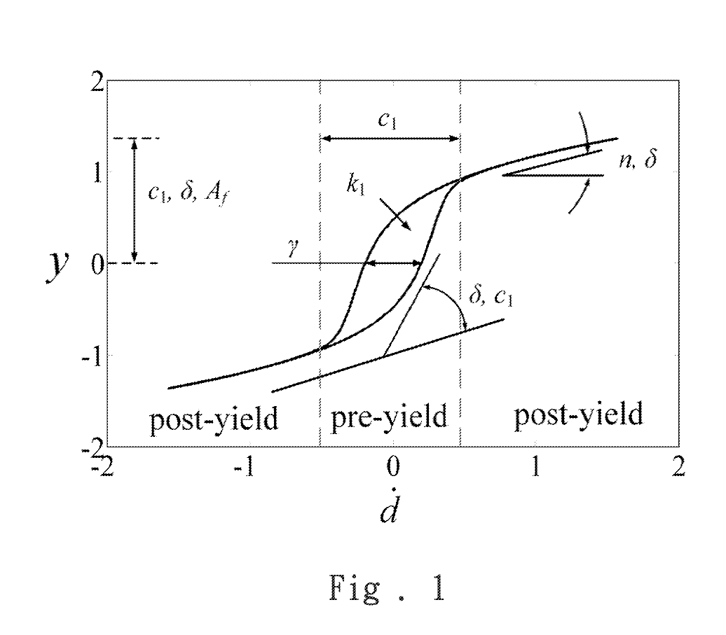

FIG. 1 shows a y-\dot{d} curve according to one embodiment of the present invention. Refer to FIG. 1 for the meanings of the parameters, including A_{f}, n, c₂, c₁ and k₁. The y-\dot{d} curve may be divided into two stages: a pre-yield stage and a post-yield stage. A_{f} is related to the maximum intensity of the hysteresis output; n is related to the slope of the post-yield stage of the y-\dot{d} curve; c₁ is related to the slope of the pre-yield stage of the y-\dot{d} curve; k₁, c₁, δ and γ are related to the path and area of the pre-yield stage of the y-\dot{d} curve.

In the present invention, the method for predicting a hysteresis curve model of a magnetorheological system is derived from the Duffing Equation, adopting a nonlinear continuous second-order ordinary differential equation. In comparison with the conventional method, the method of the present invention has a simple and stable computation process and features the ability to track parameter modifications. Therefore, the present invention can promote the computation efficiency and accuracy of the hysteresis model. Therefore, the present invention possesses utility, novelty and non-obviousness and meets the condition for a patent. Thus, the Inventors file the application for a patent. It is appreciated if the patent is approved fast.

The present invention has been fully demonstrated with the embodiments hereinbefore. However, it should be understood that these embodiments are only to exemplify the present invention but not to limit the scope of the present invention. Any equivalent modification or variation according to the spirit of the present invention is to be also included within the scope of the present invention.

What is claimed is:

1. A method for predicting a hysteresis curve model of a magnetorheological system, comprising
Step 1: providing a magnetorheological system to be predicted and providing Equation 1 and Equation 2 respectively expressed as
\ddot{x}+αx+γ\dot{x}+βxⁿ+δ\dot{x}ⁿ=k₁d+c₁\dot{d} (1)
y=A_{f}\dot{x} (2)
wherein α, β, γ and δ are parameters of the magnetorheological system, n being an odd number, k₁ and c₁ being input parameters of the magnetorheological system, d and \dot{d} respectively being an physical input value and a first-order differential of the input value, A_{f} being an output coefficient of the magnetorheological system, x being an internal state of the magnetorheological system, and y being an output of the magnetorheological system;
Step 2: fixing a magnetic field applied to the magnetorheological system, and measuring the magnetorheological system to obtain an experimental y-d curve and an experimental y-\dot{d} curve;
Step 3: selecting a plurality of groups of values of k₁, c₁, α, β, γ, δ, n and A_{f} according to the experimental y-d curve and the experimental y-\dot{d} curve;
Step 4: substituting the values into Equation 1 and Equation 2 to obtain a plurality of computed y-d curves and a plurality of computed y-\dot{d} curves;
Step 5: fitting the computed y-d curves and the computed y-\dot{d} curves to the experimental y-d curve and the experimental y-\dot{d} curve respectively to obtain the values of k₁, c₁, α, β, γ, δ, n and A_{f} corresponding to coincidence of the computed y-d curve and the experimental y-d curve and coincidence of the computed y-\dot{d} curve and the experimental y-\dot{d} curve; and
Step 6: substituting the values of k₁, c₁, α, β, γ, δ, n and A_{f}, which are obtained in Step 5, into Equation 1 and Equation 2 to obtain a model for dynamically predicting the hysteresis curve of the magnetorheological system.

2. The method for predicting a hysteresis curve model of a magnetorheological system according to claim 1, wherein in said Step 1, Equation 1 and Equation 2 are further represented by state-space functions, which are respectively expressed as Equation 3 and Equation 4:
$$\begin{matrix}[ \begin{matrix}{\dot{x}}_{1} \\ {\dot{x}}_{2}\end{matrix} ] = [ \begin{matrix}0 & 1 \\ - α & - γ\end{matrix} ] [ \begin{matrix}{x}_{1} \\ {x}_{2}\end{matrix} ] + [ \begin{matrix}0 & 0 \\ - β {x}_{1}^{n} & - δ {x}_{2}^{n}\end{matrix} ] + [ \begin{matrix}0 & 0 \\ {k}_{1} & {c}_{1}\end{matrix} ] [ \begin{matrix}d \\ \dot{d}\end{matrix} ] & ( 3 ) \\ y = [ \begin{matrix}0 & {A}_{f}\end{matrix} ] [ \begin{matrix}{x}_{1} \\ {x}_{2}\end{matrix} ] & ( 4 )\end{matrix}$$
